(19) United States
(12) Patent Application Publication
(10) Pub. No.: US 2023/0014417 A1
(43) Pub. Date: Jan. 19, 2023

(54) Three-dimensional Reflective Finish Structure

(71) Applicant: Huang Zhuang, Guangdong Province (CN)

(72) Inventor: Huang Zhuang, Guangdong Province (CN)

(21) Appl. No.: 17/376,128

(22) Filed: Jul. 14, 2021

(51) Int. Cl. B29D 11/00; B29C 33/42; F21V 7/04

(52) U.S. Cl. CPC B29D 11/00605; B29C 33/42; F21V 7/041; F21V 7/048; B29L 2011/0083

(57) ABSTRACT

The present utility model discloses a three-dimensional reflective finish structure, a plurality of three-dimensional reflective units are integrally formed on the surface of a substrate, and at least one three-dimensional reflective surface is provided on a partial surface or the entire surface of the substrate, among which, a three-dimensional reflective surface comprises a plurality of three-dimensional reflective units scattered on the surface of the substrate or continuously distributed on the surface of the substrate and connected into one piece; and a three-dimensional reflective unit comprises at least one three-dimensional polyhedral reflective pit in the shape of a polygonal cone sinking below the surface of the substrate. The present utility model is less prone to abrasion and has extremely strong abrasion resistance as the three-dimensional reflective unit relatively sinks below the surface of the substrate material; has better light gathering and reflection effects, as well as better visual effects as the three-dimensional reflective unit has a plurality of reflective surfaces arranged obliquely to the surface of the substrate; and has simple structure and low cost.

### TECHNICAL FIELD

The present utility model relates to the technical field of three-dimensional reflective finishes, in particular to a three-dimensional reflective finish structure.

### BACKGROUND ART

For products whose surface needs to be provided with a reflective layer as a surface decoration layer and make it have a reflective effect, for example, household appliances and personal products (including personal clothing and various pendants, fasteners, zippers, buttons, hairpins and various accessories, etc.), a reflective paint layer is generally sprayed on the surface of the substrate, and the reflective paint layer is used to make the surface reflective to increase the aesthetics of its appearance. However, the reflection of the reflective paint layer is traditional flat reflection. The reflective paint layer reflects the incident light only once, generally in a sheet-like overall reflection; the visual effect of flat reflection is relatively poor, and it is easy to lose the reflective function due to abrasion during use, and thus it is necessary to improve it.

### CONTENT OF UTILITY MODEL

In view of the shortcomings of the prior art, the purpose of the present utility model is to provide a three-dimensional reflective finish structure, which has a simple structure, low cost, good reflective visual effect, and strong abrasion resistance.

In order to achieve the above purpose, the technical solution adopted by the present utility model is: a three-dimensional reflective finish structure, including a substrate, a plurality of three-dimensional reflective units are integrally formed on the surface of the substrate, and at least one three-dimensional reflective surface is provided on a partial surface or the entire surface of the substrate, among which, a three-dimensional reflective surface comprises a plurality of three-dimensional reflective units scattered on the surface of the substrate or continuously distributed on the surface of the substrate and connected into one piece; and a three-dimensional reflective unit comprises at least one three-dimensional polyhedral reflective pit in the shape of a polygonal cone sinking below the surface of the substrate. The surface of the substrate is a curved surface or a flat surface, and the surface of the substrate is formed by a stamping process or an integral molding process with a plurality of hollow three-dimensional polyhedral reflective pits arranged at intervals or arranged adjacently and continuously and connected into one piece.

Compared with the prior art, the advantages of the present utility model are as follows: In the present utility model, a plurality of three-dimensional reflective units composed of a plurality of three-dimensional polyhedral reflective pits recessed below the surface of the substrate are integrally formed on the surface of the substrate. The present utility model is less prone to abrasion and has extremely strong abrasion resistance as the three-dimensional reflective unit relatively sinks below the surface of the substrate material; has better light gathering and reflection effects, as well as better visual effects as the three-dimensional reflective unit has a plurality of reflective surfaces arranged obliquely to the surface of the substrate; and has simple structure and low cost.

### BRIEF DESCRIPTION OF THE DRAWINGS

FIG. 1 is a structural schematic diagram of the present utility model.

FIG. 2 is a front view of FIG. 1.

FIG. 3 is a structural schematic diagram of a three-dimensional polyhedral reflective pit in the shape of a triangular pyramid formed on the surface of the substrate.

FIG. 4 is a structural schematic diagram of a three-dimensional reflective unit composed of six three-dimensional polyhedral reflective pits in the shape of a triangular pyramid.

FIG. 5 is a schematic diagram of the continuous arrangement of the three-dimensional reflective unit shown in FIG. 4.

FIG. 6 is a structural schematic diagram of a three-dimensional polyhedral reflective pit in the shape of a quadrangular pyramid formed on the surface of the substrate.

FIG. 7 is a structural schematic diagram of a three-dimensional polyhedral reflective pit in the shape of a pentagonal pyramid formed on the surface of the substrate.

FIG. 8 is a structural schematic diagram of a three-dimensional polyhedral reflective pit in the shape of a hexagonal pyramid formed on the surface of the substrate.

FIG. 9 is a structural schematic diagram in which a plurality of three-dimensional polyhedral reflective pits are respectively formed on the upper surface and the side surface of the substrate.

### DETAILED DESCRIPTION OF EMBODIMENTS

The three-dimensional reflective finish structure of the present utility model can be applied to the shells of various electronic products and various household appliances. The utility model can also be applied to the surface of various personal products including personal clothing and various pendants, fasteners, zippers, buttons, hairpins and various accessories, etc., that is, the three-dimensional reflective finish structure is formed on the surface of the body or the shell where various products are exposed, or it can be made into a separate sheet-shaped decorative sheet fixed on the surface of various products, and the three-dimensional reflective finish structure can be formed on the surface of a metal or plastic substrate.

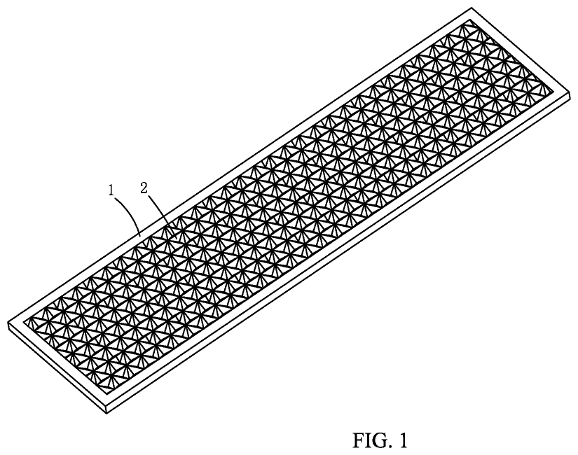

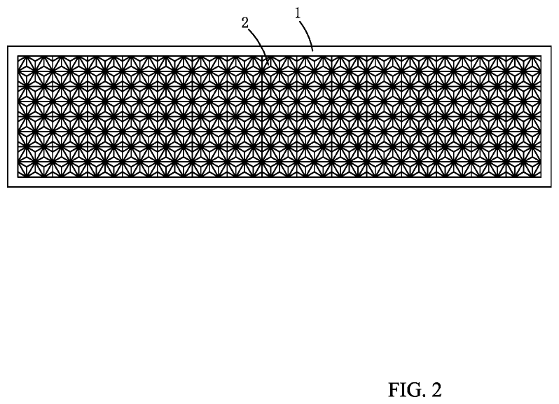

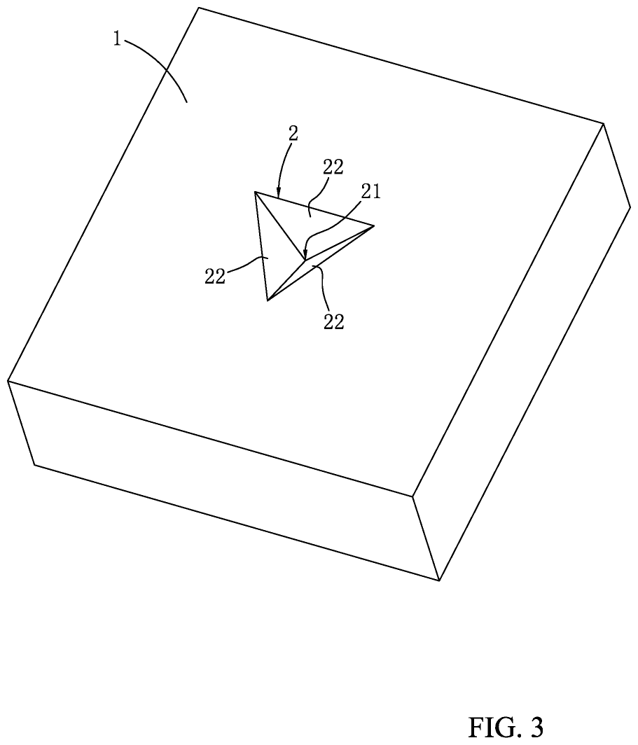

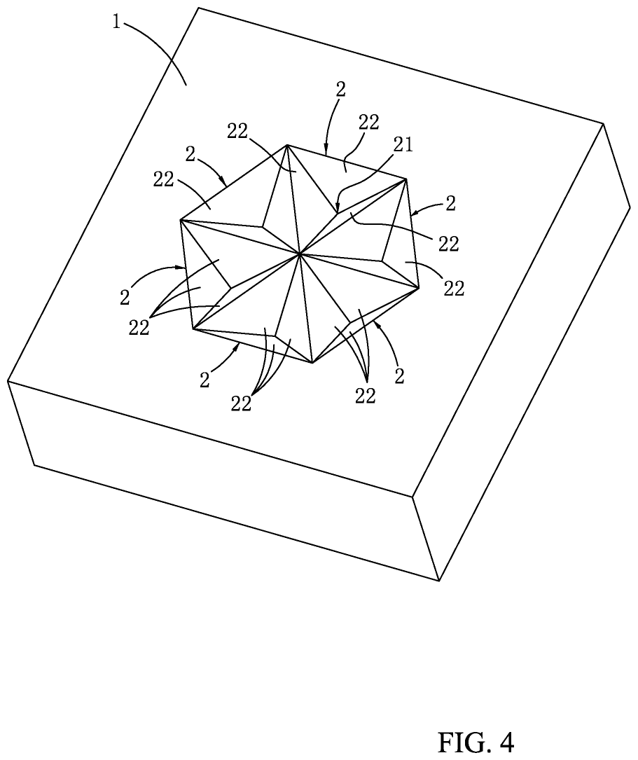

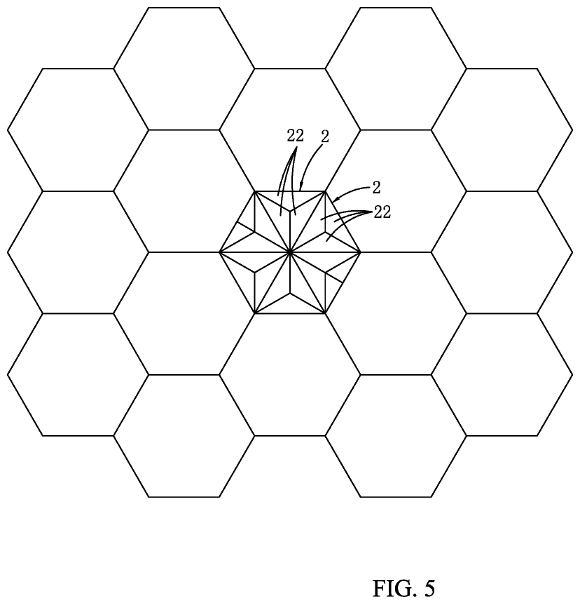

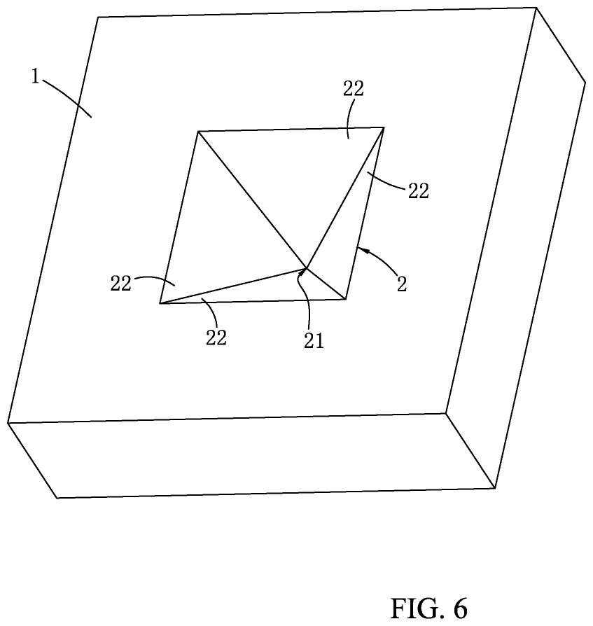

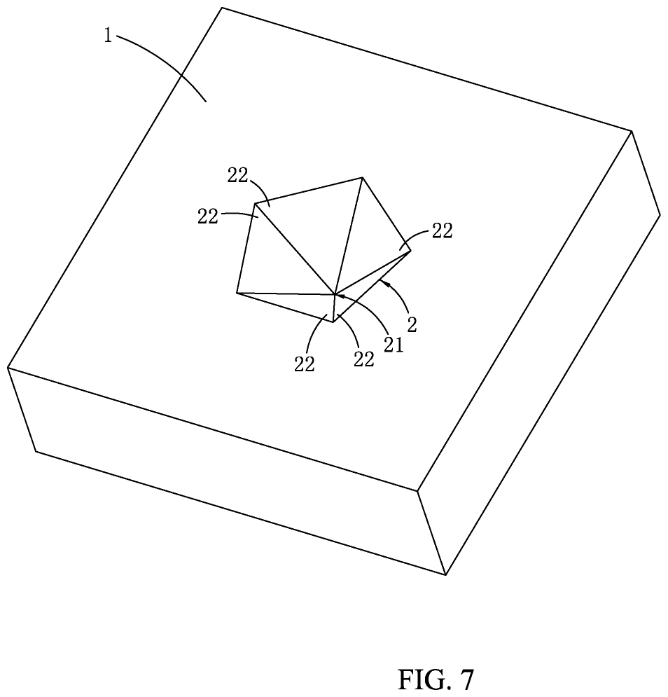

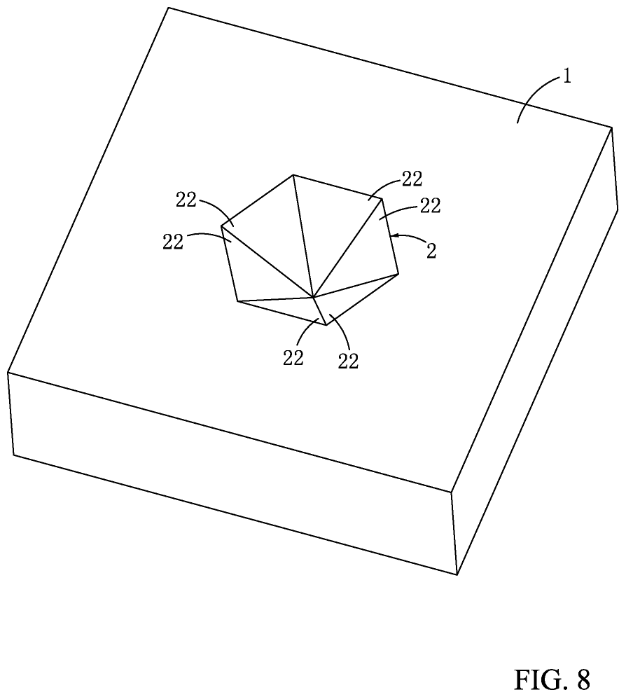

A three-dimensional reflective finish structure, as shown in FIG. 1 to FIG. 9, comprising a substrate 1, a plurality of three-dimensional reflective units are integrally formed on the surface of the substrate 1, and at least one three-dimensional reflective surface is provided on a partial surface of the substrate 1, alternatively, at least one three-dimensional reflective surface is provided on the entire surface of the substrate 1, a plurality of three-dimensional reflective surfaces are provided on the same surface of the substrate 1, and the three-dimensional reflective surfaces on the same surface of the substrate 1 are arranged at intervals.

Preferably, three-dimensional reflective surfaces are respectively provided on the surfaces of a plurality of different sides of the substrate 1, and the three-dimensional reflective surfaces provided on the surfaces of adjacent two sides of the substrate 1 are connected as a whole, alternatively, the three-dimensional reflective surfaces provided on the surfaces of adjacent two sides of the substrate 1 are arranged at intervals.

A three-dimensional reflective surface comprises a plurality of three-dimensional reflective units scattered on the surface of the substrate 1 and arranged at intervals, alternatively, a three-dimensional reflective surface comprises a plurality of three-dimensional reflective units continuously distributed on the surface of the substrate 1 and connected into one piece. That is, each three-dimensional reflective unit formed on the surface of the substrate 1 and the three-dimensional reflective surface composed of three-dimensional reflective units may be connected into a piece or spaced apart from each other.

Optionally, a three-dimensional reflective unit comprises at least one three-dimensional polyhedral reflective pit 2 in the shape of a polygonal cone, which is recessed or sinks below the surface of the substrate 1 and the tip portion 21 of which faces downward; and a three-dimensional reflective unit comprises at least one three-dimensional polyhedral reflective pit 2 in the shape of a polygonal cone, which protrudes on the surface of the substrate 1 and the tip portion 21 of which faces upward. Preferably, the three-dimensional reflective unit formed on the surface of the substrate 1 comprises a three-dimensional polyhedral reflective pit 2 with the tip portion 21 facing upward and a three-dimensional polyhedral reflective pit 2 with the tip portion 21 facing downward.

Optionally, the surface of the substrate 1 is provided with a plurality of three-dimensional polyhedral reflectors in the shape of a platform or in a special shape, spaced at least two reflective sides and distributed on the three-dimensional reflective surface, which are sunk below or protruded above the surface of the substrate 1. Preferably, the three-dimensional polyhedral reflective pit 2 formed on the surface of the substrate 1 may be of any shape other than a polygonal cone, including possible slight deformation of the shape during the production process.

Preferably, each three-dimensional reflective unit comprises at least one three-dimensional polyhedral reflective pit 2, all of which are recessed below the surface of the substrate 1, and the shape of the three-dimensional polyhedral reflective pit 2 is a polygonal cone.

The surface of the substrate 1 is formed by a stamping process or an integral molding process with hollow three-dimensional polyhedral reflective pits 2 arranged at intervals.

The surface of the substrate 1 is a curved surface or a flat surface, and a curved surface comprises an arc-shaped curved surface and a special-shaped curved surface; the surface of the substrate 1 is processed by a surface knurling process, an embossing process, a stamping process or an integral molding process, and then the surface of the substrate 1 is formed with hollow three-dimensional polyhedral reflective pits 2 arranged adjacently and continuously and connected into one piece.

The three-dimensional polyhedral reflective pits 2 can be formed on various curved surfaces and arranged following the curved surfaces. In the present utility model, a plurality of three-dimensional reflective units composed of a plurality of three-dimensional polyhedral reflective pits 2 recessed below the surface of the substrate 1 are integrally formed on the surface of the substrate 1. The present utility model is less prone to abrasion and has extremely strong abrasion resistance as the three-dimensional reflective unit relatively sinks below the surface of the substrate 1 material; has better reflective visual effect as the three-dimensional reflective unit has a plurality of reflective surfaces arranged obliquely to the surface of the substrate 1; and has simple structure and low cost.

Preferably, a plurality of three-dimensional polyhedral reflective pits 2 are combined and arranged to form a three-dimensional reflective unit; a three-dimensional reflective unit comprises the three-dimensional polyhedral reflective pits 2 with different heights and different shapes of the cone bottom surface, so as to form a more complex three-dimensional reflective surface on the surface of the substrate 1; the three-dimensional reflective surface has a variety of three-dimensional polyhedral reflective pits 2 with different sizes, different overall light reflection directions, and different depths, all within a specified range, and a more dazzling visual effect can be obtained; especially in the observation process of moving, rotating or shaking relative to the human eye, it can be observed that the reflective area on the surface of the substrate 1 and the number and intensity of each reflective point in each reflective area have more obvious changes, that is, it has the visual effect of shining or flickering light spots with more obvious changes.

Each three-dimensional polyhedral reflective pit 2 has a plurality of inner reflective wall surfaces 22, each inner reflective wall surface 22 is located below the surface of the substrate 1, each inner reflective wall surface 22 is arranged obliquely with respect to the surface of the substrate 1, and each inner reflective wall surface 22 of each three-dimensional polyhedral reflective pit 2 is attached with a reflective layer. Preferably, the surface of the substrate 1 and the surface of each inner reflective wall surface 22 of each three-dimensional polyhedral reflective pit 2 are attached with a reflective layer through an electroplating process, and the reflective layer attached to the surface of the substrate 1 and the reflective layer attached to the surface of the inner reflective wall surface 22 are integrated.

After the light is irradiated on the surface of the substrate 1, the light is incident into each three-dimensional polyhedral reflective pit 2 through the cone bottom surface of each three-dimensional polyhedral reflective pit 2 respectively; the incident light is reflected by at least two inner reflective wall surfaces 22 and then is reflected out via the cone bottom surface of each corresponding three-dimensional polyhedral reflective pit 2; since each three-dimensional polyhedral reflective pit 2 has a specific height or depth, basically all incident light can be reflected out through the cone bottom surface in a concentrated manner; according to the principle of equiangular reflection of light, light rays with different incident angles relative to the surface of the substrate 1 will be collected into parallel light after being incident on the three-dimensional polyhedral reflective pit 2 and concentratedly reflected out through the cone bottom surface. The visual performance when observed by the human eye is that a bright spot or a hot spot is seen at a three-dimensional polyhedral reflective pit 2; when the substrate 1 is observed by the human eye, for each three-dimensional polyhedral reflective pit 2, the human eye can observe a relatively bright reflective bright spot or small reflective area; a relatively small area of the cone bottom surface is represented as a bright spot, and a small reflective area with a relatively large area of the cone bottom surface is represented as a hot spot; therefore, the overall visual effect is that the surface of the substrate 1 is covered with various small bright spots or hot spots, and the bright spots or hot spots change with the change of the light and the observation angle, thereby obtaining an excellent shining visual effect similar to a full diamond inlaid with small diamonds.

Specifically, the shape of the cross section where the three-dimensional polyhedral reflective pit 2 intersects with the substrate 1 is a polygon, and the shape of the three-dimensional polyhedral reflective pit 2 comprises a triangular pyramid, a quadrangular pyramid, a pentagonal pyramid, a hexagonal pyramid, a heptagonal pyramid, and an octagonal pyramid. For example, a three-dimensional reflective unit comprises six three-dimensional polyhedral reflective pits 2 each in the shape of a triangular pyramid, each three-dimensional reflective unit has a cone bottom surface in the shape of a triangle, the cone bottom surface of the six three-dimensional polyhedral reflective pits 2 are spliced on the surface of the substrate 1 into a light incident surface in the shape of a hexagon, and the arrangement rule of each three-dimensional reflective unit on the surface of the substrate 1 is that the six sides of the light incident surface of each three-dimensional reflective unit are respectively connected with another three-dimensional reflective unit; and a three-dimensional polyhedral reflective pit 2 has three inner reflective wall surfaces 22, any two inner reflective wall surfaces 22 are perpendicular to each other, and the shape of each inner reflective wall surface 22 is an isosceles right triangle with an acute angle of 45 degrees.

A three-dimensional polyhedral reflective pit 2 in the shape of a quadrangular pyramid can be used as a three-dimensional reflective unit, and a three-dimensional polyhedral reflective pit 2 in the shape of a hexagonal pyramid can also be used as a three-dimensional reflective unit; in addition, three-dimensional polyhedral reflective pits 2 in various shapes may be formed on the surface of the substrate 1.

Optionally, the surface of the substrate 1 is formed with a plurality of three-dimensional reflective units arranged continuously in a regular manner and three-dimensional polyhedral reflective pits 2 filled in the arrangement gaps between adjacent three-dimensional reflective units. Each three-dimensional polyhedral reflective pit 2 has a tip portion 21 and a cone bottom surface; each three-dimensional polyhedral reflective pit 2 has its head facing downward and sinks at a position below the surface of the substrate 1; the tip portion 21 of the three-dimensional polyhedral reflective pit 2 faces downward, the cone bottom surface faces upward and is in the shape of a polygon, and the cone bottom surface is not higher than the surface of the substrate 1. the height of the three-dimensional polyhedral reflective pit 2 is set at 0.02-2 mm and is smaller than the side length of the cone bottom surface, so as to obtain a polyhedral reflective pit with sufficient depth and a relatively larger total reflection area.

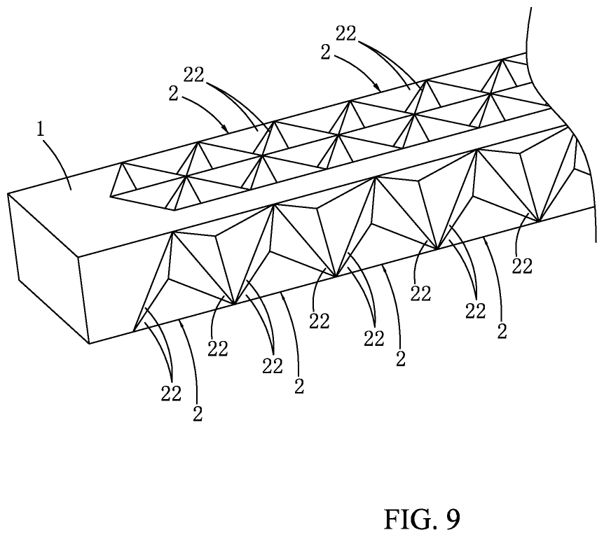

A plurality of three-dimensional polyhedral reflective pits 2 can be formed on the front and side surfaces of the substrate 1, as shown in FIG. 9; for the side surface of the substrate 1 with a relatively narrow width, 1 to 3 rows of three-dimensional reflective units may be formed on the side surface only, and each row of the three-dimensional reflective units is provided with at least one three-dimensional polyhedral reflective pit 2; for example, each row of three-dimensional reflective units formed on the side surface of the substrate 1 is only provided with a three-dimensional polyhedral reflective pit 2 in the shape of a quadrilateral cone; and for example, each row of three-dimensional reflective units formed on the side surface of the substrate 1 is only provided with two three-dimensional polyhedral reflective pits 2 in the shape of a triangular cone.

1. A three-dimensional reflective finish structure, comprising a substrate (1), wherein: a plurality of three-dimensional reflective units are integrally formed on the surface of the substrate (1), and at least one three-dimensional reflective surface is provided on a partial surface or the entire surface of the substrate (1), among which,
a three-dimensional reflective surface comprises a plurality of three-dimensional reflective units scattered on the surface of the substrate (1) or continuously distributed on the surface of the substrate (1) and connected into one piece; and
a three-dimensional reflective unit comprises at least one three-dimensional polyhedral reflective pit (2) in the shape of a polygonal cone sinking below the surface of the substrate (1).

2. The three-dimensional reflective finish structure according to claim 1, wherein: the surface of the substrate (1) is a curved surface or a flat surface, and the surface of the substrate (1) is formed by a stamping process or an integral molding process with a plurality of hollow three-dimensional polyhedral reflective pits (2) arranged at intervals or arranged adjacently and continuously and connected into one piece.

3. The three-dimensional reflective finish structure according to claim 1, wherein: the three-dimensional reflective unit comprises at least one three-dimensional polyhedral reflective pit (2) in the shape of a polygonal cone, which is recessed or sinks below the surface of the substrate (1) and the tip portion (21) of which faces downward, and at least one three-dimensional polyhedral reflective pit (2) in the shape of a polygonal cone, which protrudes on the surface of the substrate (1) and the tip portion (21) of which faces upward,
alternatively,
the surface of the substrate (1) is provided with a plurality of three-dimensional polyhedral reflectors in the shape of a platform or in a special shape, spaced at least two reflective sides and distributed on the three-dimensional reflective surface, which are sunk below or protruded above the surface of the substrate (1).

4. The three-dimensional reflective finish structure according to claim 1, wherein: each of the three-dimensional polyhedral reflective pits (2) has a tip portion (21) and a cone bottom surface, the three-dimensional polyhedral reflective pits (2) sink as a whole at a position below the surface of the substrate (1), the tip portion (21) of the three-dimensional polyhedral reflective pit (2) faces downward, the cone bottom surface faces upward, and the cone bottom surface is not higher than the surface of the substrate (1); and the shape of the cross section where the three-dimensional polyhedral reflective pit (2) intersects with the substrate (1) is a polygon.

5. The three-dimensional reflective finish structure according to claim 4, wherein: the surface of the substrate (1) is arranged with a plurality of the three-dimensional reflective units arranged continuously in a regular manner, and one three-dimensional reflective unit comprises a plurality of the three-dimensional polyhedral reflective pits (2) connected into one piece after being arranged in combination; and the shape of the three-dimensional polyhedral reflective pit (2) includes, but is not limited to, a triangular pyramid, a quadrangular pyramid, a pentagonal pyramid, a hexagonal pyramid, a heptagonal pyramid, and an octagonal pyramid.

6. The three-dimensional reflective finish structure according to claim 4, wherein: one of the three-dimensional reflective units comprises the three-dimensional polyhedral reflective pits (2) with different heights and/or different shapes of the cone bottom surface, and the height of the three-dimensional polyhedral reflective pit (2) is smaller than the side length of its cone bottom surface; and
there is an arrangement gap between the three-dimensional reflective units arranged adjacently on the three-dimensional reflective surface, and at least one of the three-dimensional polyhedral reflective pits (2) with different shapes is formed at the arrangement gap.

7. The three-dimensional reflective finish structure according to claim 6, wherein: each of the three-dimensional polyhedral reflective pits (2) has a plurality of inner reflective wall surfaces (22), each of the inner reflective wall surfaces (22) is located below the surface of the substrate (1), each inner reflective wall surface (22) is arranged obliquely with respect to the surface of the substrate (1), and each inner reflective wall surface (22) of each three-dimensional polyhedral reflective pit (2) is attached with a reflective layer.

8. The three-dimensional reflective finish structure according to claim 7, wherein: the surface of the substrate (1) and the surface of each inner reflective wall surface (22) of each three-dimensional polyhedral reflective pit (2) are attached with a reflective layer through an electroplating process, and the reflective layer attached to the surface of the substrate (1) and the reflective layer attached to the surface of the inner reflective wall surface (22) are integrated.

9. The three-dimensional reflective finish structure according to claim 7, wherein: one of the three-dimensional reflective units comprises six said three-dimensional polyhedral reflective pits (2) each in the shape of a triangular pyramid, each three-dimensional reflective unit has a cone bottom surface in the shape of a triangle, the cone bottom surface of the six three-dimensional polyhedral reflective pits (2) are spliced on the surface of the substrate (1) into a light incident surface in the shape of a hexagon, and the arrangement rule of each three-dimensional reflective unit on the surface of the substrate (1) is that the six sides of the light incident surface of each three-dimensional reflective unit are respectively connected with another three-dimensional reflective unit.

10. The three-dimensional reflective finish structure according to claim 9, wherein: one of the three-dimensional polyhedral reflective pits (2) has three inner reflective wall surfaces (22), any two inner reflective wall surfaces (22) are perpendicular to each other, and the shape of each inner reflective wall surface (22) is an isosceles right triangle with an acute angle of 45 degrees.
